(19) United States
(12) Patent Application Publication
(10) Pub. No.: US 2012/0094612 A1
(43) Pub. Date: Apr. 19, 2012

(54) ELECTRONIC SYSTEM AND CONTROLLING METHOD THEREOF

(76) Inventors: Matthew W. Taylor, Bellevue, WA (US); Tsung-Pao Kuan, Taoyuan County (TW); Sung-Shih Yu, Taoyuan County (TW)

(21) Appl. No.: 12/904,175

(22) Filed: Oct. 14, 2010

(51) Int. Cl. H04B 1/38

(52) U.S. Cl. 455/73

(57) ABSTRACT

An electronic system includes a first wireless transceiving module having a device identification code and a portable device. The portable device may include a second wireless transceiving module, a storage module, and a processor. The second wireless transceiving module obtains the device identification code from the first wireless transceiving module. The storage module may store at least one set of data, wherein each set of data may comprise a pre-built identification code and a corresponding pre-assigned instruction. When the second wireless transceiving module obtains the device identification code from the first wireless transceiving module, the processor may be able to search for the at least one set of data to check whether the device identification code matches to the pre-built identification code stored in the storage module; and when the device identification code matches to the pre-built identification code, the processor may automatically execute the corresponding pre-assigned instruction.

### BACKGROUND OF THE INVENTION

1. Field of the Invention

The present disclosure relates to an electronic system and a related controlling method, and more particularly, to an electronic system and a related controlling method for automatically executing a corresponding pre-assigned instruction (such as, automatically disabling a SMS program) when a searched device identification code matches to its pre-built identification code(s).

2. Description of the Prior Art

In the modern information society with flourishing wireless communications, a portable device, such as a cell phone, has become one of the most common communication tools. The cell phone allows users to perform wireless communications anytime and anywhere, and thereby to perform voice communications conveniently.

Since the cell phone brings more convenience to users, the users become too depend upon the cell phone. However, this may result in some problems with the users under some conditions. As an illustration, the users may launch a SMS program for texting on the cell phone while they are driving, which is very dangerous and may cause accidents. As another illustration, when the users enter a cinema, a sudden large ring volume may bother the users and other people if an incoming call is received by the cell phone at this time.

Therefore, how to improve convenience of the portable device, and increase more additional features to the portable device become important topics in this field.

### SUMMARY OF THE INVENTION

According to the present disclosure, roughly described, an electronic system and a related controlling method for automatically executing a corresponding pre-assigned instruction when a searched device identification code matches to its pre-built identification code(s).

According to one embodiment, an electronic system is provided. The electronic system may include a first wireless transceiving module and a portable device. The first wireless transceiving module has a device identification code. The portable device may include a second wireless transceiving module, a storage module, and a processor. The second wireless transceiving module may be used for communicating with the first wireless transceiving module in order to obtain the device identification code from the first wireless transceiving module. The storage module stores at least one set of data, wherein each set of data may comprise a pre-built identification code and a corresponding pre-assigned instruction. The processor may be coupled to the second wireless transceiving module and the storage module. When the second wireless transceiving module obtains the device identification code from the first wireless transceiving module, the processor searches for the at least one set of data to check whether the device identification code matches to the pre-built identification code stored in the storage module; and when the device identification code matches to the pre-built identification code, the processor automatically executes the corresponding pre-assigned instruction.

In one embodiment, when the device identification code matches to the pre-built identification code, the processor may automatically disable a short message service (SMS) program.

According to one embodiment, a method for controlling an electronic system is provided. The electronic system may include a first wireless transceiving module having a device identification code and a portable device having a second wireless transceiving module. The method may include the steps of: communicating with the first wireless transceiving module in order to obtain the device identification code; storing at least one set of data, wherein each set of data comprises a pre-built identification code and a corresponding pre-assigned instruction; when the device identification code is obtained from the first wireless transceiving module, searching for the at least one set of data to check whether the device identification code matches to the pre-built identification code; and when the device identification code matches to the pre-built identification code, automatically executing the corresponding pre-assigned instruction.

### BRIEF DESCRIPTION OF THE DRAWINGS

FIG. 1 is a block diagram of an electronic system.

FIG. 2 is a block diagram of an electronic system.

FIG. 3 is flowchart illustrating a method for controlling an electronic system according to an exemplary embodiment of the present disclosure.

FIG. 4 is flowchart illustrating a method for controlling an electronic system according to another exemplary embodiment of the present disclosure.

### DETAILED DESCRIPTION

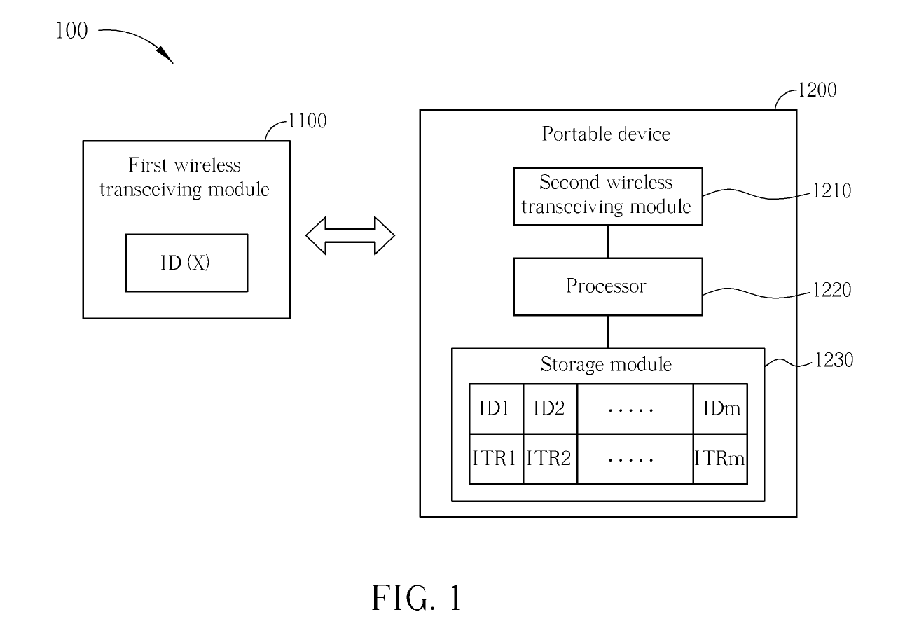

Please refer to FIG. 1. FIG. 1 is a block diagram of an electronic system 100. As shown in FIG. 1, the electronic system 100 may include a first wireless transceiving module 1100 and a portable device 1200. The first wireless transceiving module 1100 has a device identification code ID(X). The portable device 1200 may include, but is not limited to, a second wireless transceiving module 1210, a storage module 1230, and a processor 1220. The second wireless transceiving module 1210 maybe used for communicating with the first wireless transceiving module 1100 in order to obtain the device identification code ID(X) from the first wireless transceiving module 1100. The storage module 1230 may store at least one set of data. In this embodiment, the storage module 1230 stores a plurality of sets of data, wherein each set of data may comprise a pre-built identification code (e.g., ID1˜IDm) and a corresponding pre-assigned instruction (e.g. ITR1˜ITRm). The number of the pre-built identification codes and the number of the corresponding pre-assigned instructions stored in the storage module 1230 may not be limited.

In addition, the processor 1220 may be coupled to the second wireless transceiving module 1210 and the storage module 1230. What calls for special attention is that when the second wireless transceiving module 1210 obtains the device identification code ID (X) from the first wireless transceiving module 1100, the processor 1220 searches for the at least one set of data to check whether the device identification code ID(X) matches to the pre-built identification code(s) ID1˜IDm stored in the storage module 1230; and when the device identification code ID(X) matches to any one of the pre-built identification code(s) ID1˜IDm, the processor 1220 automatically executes the corresponding pre-assigned instruction(s) ITR1˜ITRm.

In the following descriptions, several examples are cited for illustrating how the processor 1220 may determine whether to automatically execute the corresponding pre-assigned instruction(s) ITR1˜ITRm. Be noted that, in one embodiment, the pre-assigned instruction may indicate the processor 1220 to enable a corresponding application; in another embodiment, the pre-assigned instruction may indicate the processor 1220 to disable a corresponding application, which also belongs to the scope of the present disclosure.

In a first case, assume that the first wireless transceiving module 1100 is disposed on a transport (e.g., a car). When a user of the portable device 1200 gets into the car, the second wireless transceiving module 1210 may be able to search for the first wireless transceiving module 1100 so as to obtain the device identification code ID(X) from the first wireless transceiving module 1100. At this time, the processor 1220 starts to search for the at least one set of data to check whether the device identification code ID(X) matches to any one of the pre-built identification code(s) ID1˜IDm stored in the storage module 1230. For example, when the device identification code ID(X) matches to the pre-built identification code ID1, the processor 1220 may automatically disable at least one of the following functions of the portable device 1200 including a short message service (SMS) program, a multimedia messaging service (MMS), a voice recognition, a speaker function, a microphone function, a data input function, a keyboard function, and a display function (i.e., the corresponding pre-assigned instruction ITR1).

In a second case, assume that the first wireless transceiving module 1100 is disposed in a cinema. When a user of the portable device 1200 enters the cinema, the second wireless transceiving module 1210 may be able to search for the first wireless transceiving module 1100 so as to obtain the device identification code ID(X) from the first wireless transceiving module 1100. At this time, the processor 1220 may start to search for the at least one set of data to check whether the device identification code ID(X) matches to any one of the pre-built identification code(s) ID1˜IDm stored in the storage module 1230. For example, when the device identification code ID(X) matches to the pre-built identification code ID2, the processor 1220 may automatically enable a mute function of the portable device 1200 (i.e., the corresponding pre-assigned instruction ITR2).

Certainly, the abovementioned electronic system 100 is presented merely to illustrate a practicable embodiment of the present disclosure. In other embodiments, more functions may be designed to portable device 1200 in order to provide more choices to the portable device 1200. For example, a speed detecting function may be added into the portable device 1200.

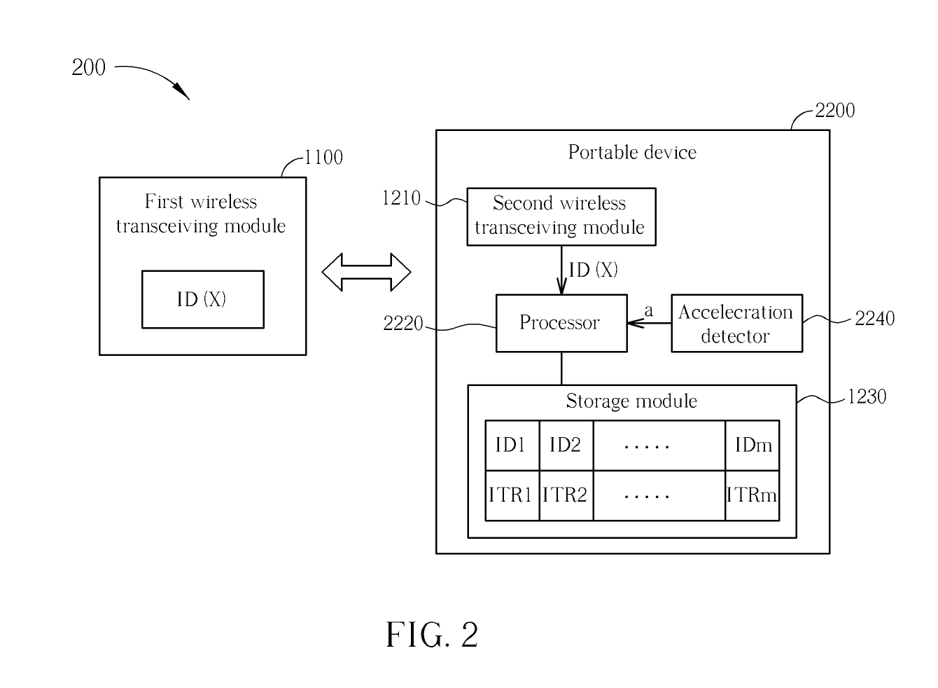

Please refer to FIG. 2. FIG. 2 is a block diagram of an electronic system 200 according to a second embodiment of the present disclosure. In FIG. 2, the architecture of the electronic system 200 is similar to that of the electronic system 100, and the difference between them is that a portable device 2200 of the electronic system 200 further includes an acceleration detector 2240 coupled to the processor 2220. The acceleration detector 2240 may detect an acceleration behavior of the portable device 2200 to be inputted to the processor 2220. In this embodiment, when the device identification code ID(X) matches to any one of the pre-built identification code(s) ID1˜IDm, the processor 2220 may determine whether to execute the corresponding pre-assigned instruction ITR1˜ITRm according to the acceleration behavior.

As an illustration, in a third case, assume that the first wireless transceiving module 1100 is disposed on a transport (e.g., a car). When a user of the portable device 2200 gets into the car, the second wireless transceiving module 1210 may be able to search for the first wireless transceiving module 1100 so as to obtain the device identification code ID(X) from the first wireless transceiving module 1100. At this time, the processor 2220 may start to search for the at least one set of data to check whether the device identification code ID(X) matches to any one of the pre-built identification code(s) ID1˜IDm stored in the storage module 1230. Under this condition, when the device identification code ID(X) matches to the pre-built identification code ID1, the acceleration detector 2240 detects the acceleration behavior and then the processor 2220 may determine whether to execute the corresponding pre-assigned instruction ITR1 according to the acceleration behavior. For example, when the acceleration behavior is determined to be car moving (i.e., the speed is greater than a threshold TH for a while), which means that the portable device 2200 is on-the-move, the processor 2220 may determine to execute the corresponding pre-assigned instruction ITR1 (that is, automatically disabling at least one of the following functions of the portable device 2200 including a SMS program, a multimedia messaging service (MMS), a voice recognition, a speaker function, a microphone function, a data input function, a keyboard function, and a display function). When the acceleration behavior is determined to be car stop (i.e., the speed is smaller than the threshold TH for a while), which means the portable device 2200 is almost stationary, the processor 2220 may determine to not execute the corresponding pre-assigned instruction ITR1.

Please note that the acceleration detector 2240 may be implemented by a G sensor, a Wi-Fi module, an RFID module, a base station, a radio signal transceiving module, or a global positioning system (GPS) module, but this should not be considered as limitations of the present disclosure. Moreover, the first wireless transceiving module 1100 and the second wireless transceiving module 1210 may be implemented by a Bluetooth module, a Wi-Fi module, an RFID module, a base station, a radio signal transceiving module, a ZigBee module, or an ANT/ANT+ module, respectively, but the present disclosure is not limited to this only. The portable device 1200/2200 may be a cell phone, a personal digital assistant (PDA), a PDA phone, a smart phone, a hand held device, a e-book, a tablet, or a laptop. But this is not meant to be a limitation of the present disclosure, and the portable device 1200/2200 may be a portable device of other types.

As may be known from descriptions above, the processor 1220/2220 may be able to determine whether to automatically execute the corresponding pre-assigned instruction ITR1˜ITRm when the device identification code ID(X) matches to the pre-built identification code ID1˜IDm. The user does not need to enable or disable the corresponding application(s) manually, such as disabling a SMS program or enabling a mute function of the portable device 1200/2200. Therefore, the convenience of the portable device may be substantially improved.

On the other hand, since the second wireless transceiving module 1210 (e.g., a Bluetooth module, a Wi-Fi module, an RFID module, a base station, a radio signal transceiving module, a ZigBee module, or an ANT/ANT+ module) and the acceleration detector 2240 (e.g., a G sensor or a GPS module) consume power; none of them may need to be continuously activated. For this reason, the second wireless transceiving module 1210 and/or the acceleration detector 2240 may be activated only when a command related to the corresponding application is received by the processor 1220/2220. For example, only when a command related to launching a SMS program (or receiving an incoming call) is received by the processor 1220/2220, the second wireless transceiving module 1210 and/or the acceleration detector 2240 will be activated.

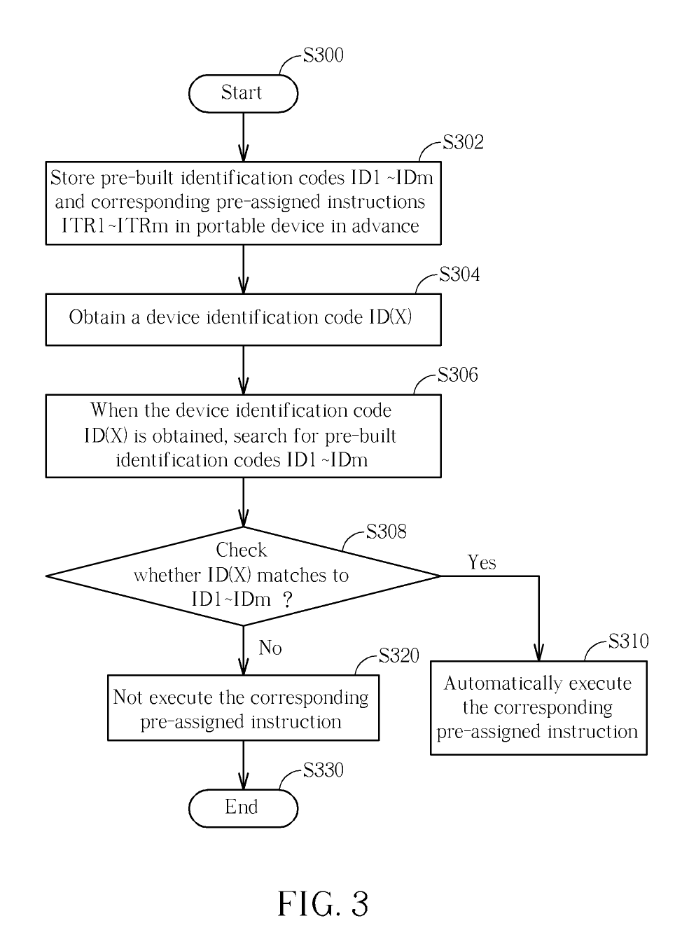

Please refer to FIG. 3. FIG. 3 is flowchart illustrating a method for controlling an electronic system according to an exemplary embodiment of the present disclosure. Please note that the following steps are not limited to be performed according to the exact sequence shown in FIG. 3 if a roughly identical result may be obtained. The method includes, but is not limited to, the following steps:

Step S300: Start.

Step S302: Store at least one set of data in the portable device in advance, wherein each set of data comprises a pre-built identification code and a corresponding pre-assigned instruction.

Step S304: Communicate with the first wireless transceiving module in order to obtain the device identification code.

Step S306: When the device identification code is obtained from the first wireless transceiving module, search for the at least one set of data.

Step S308: Check whether the device identification code matches to the pre-built identification code. When the device identification code matches to the pre-built identification code, go to Step S310; otherwise, go the Step S320.

Step S310: Automatically execute the corresponding pre-assigned instruction.

Step S320: Not execute the corresponding pre-assigned instruction.

Step S330: End.

How each element operates may be known by combining the steps shown in FIG. 3 and the elements shown in FIG. 1. Be noted that the step S302 is executed by the storage module 1230, the step S304 is executed by the second wireless transceiving module 1210, and the steps S306, S308, S310 and S320 are executed by the processor 1220. In details, in Step S302, the storage module 1230 may store at least one set of data, wherein each set of data may comprise a pre-built identification code (e.g., ID1˜IDm) and a corresponding pre-assigned instruction (e.g. ITR1˜ITRm). In Step S304, the second wireless transceiving module 1210 maybe used for communicating with the first wireless transceiving module 1100 in order to obtain the device identification code ID(X) from the first wireless transceiving module 1100. When the second wireless transceiving module 1210 obtains the device identification code ID(X) from the first wireless transceiving module 1100, the processor 1220 may search for the at least one set of data to check whether the device identification code ID(X) matches to the pre-built identification code(s) ID1˜IDm stored in the storage module 1230 (i.e., the steps S306 and S308). When the device identification code matches to the pre-built identification code, the flowchart goes to Step S310 in order to automatically execute the corresponding pre-assigned instruction; or when the device identification code does not match to the pre-built identification code, the flowchart goes to Step S320 in order not to execute the corresponding pre-assigned instruction. Moreover, the flowchart shown in FIG. 3 maybe suitable for the first case and the second case mentioned above.

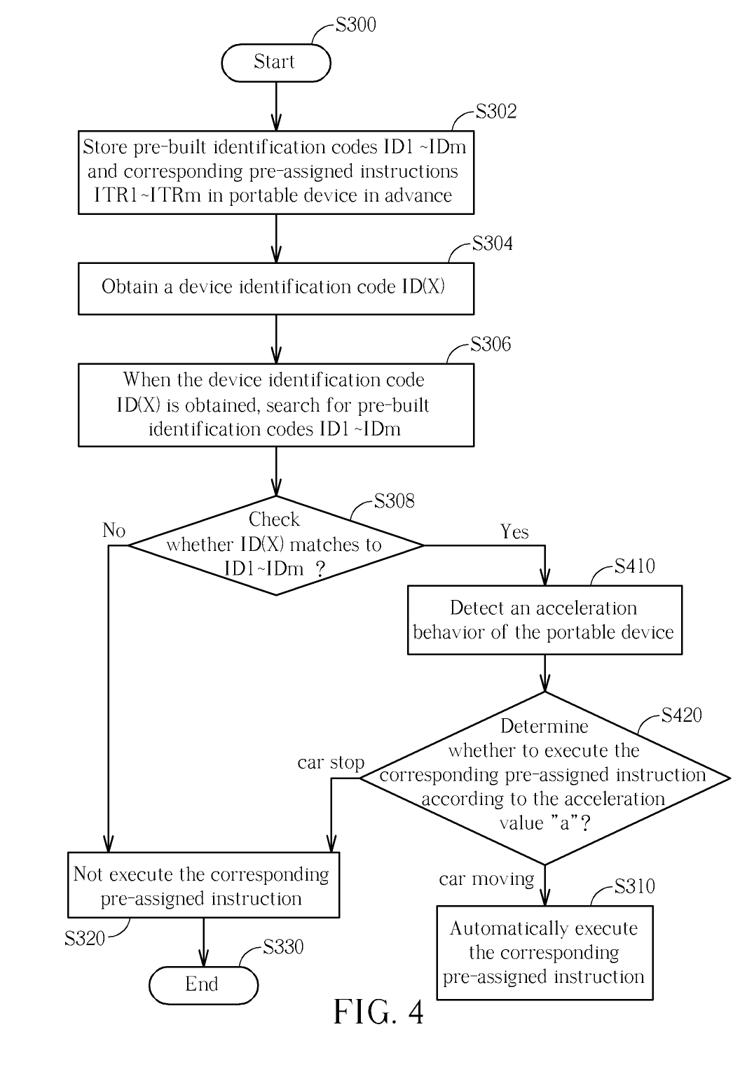

Please refer to FIG. 4. FIG. 4 is flowchart illustrating a method for controlling an electronic system according to another exemplary embodiment of the present disclosure. The method includes, but is not limited to, the following steps:

Step S300: Start.

Step S302: Store at least one set of data in the portable device in advance, wherein each set of data comprises a pre-built identification code and a corresponding pre-assigned instruction.

Step S304: Communicate with the first wireless transceiving module in order to obtain the device identification code.

Step S306: When the device identification code is obtained from the first wireless transceiving module, search for the at least one set of data.

Step S308: Check whether the device identification code matches to the pre-built identification code. When the device identification code matches to the pre-built identification code, go to Step S410; otherwise, go the Step S320.

Step S410: Detect an acceleration behavior of the portable device.

Step S420: Determine whether to execute the corresponding pre-assigned instruction according to the acceleration behavior. When the acceleration behavior is determined to be car stop, go to Step S320; when the acceleration behavior is determined to be car moving, go the Step S310.

Step S310: Automatically execute the corresponding pre-assigned instruction.

Step S320: Not execute the corresponding pre-assigned instruction.

Step S330: End.

The steps of the flowchart shown in FIG. 4 is similar to that shown in FIG. 3, and the difference between them is that a speed detecting function (i.e., the steps S410 and S420) is added into the flowchart shown in FIG. 4. How each element operates may be known by combining the steps shown in FIG. 4 and the elements shown in FIG. 2. Be noted that the step S410 is executed by the acceleration detector 2240, and the step S420 is executed by the processor 2220. In details, in Step S302, the storage module 1230 may store at least one set of data, wherein each set of data may comprise a pre-built identification code (e.g., ID1˜IDm) and a corresponding pre-assigned instruction (e.g. ITR1˜ITRm). In Step S304, the second wireless transceiving module 1210 may be used for communicating with the first wireless transceiving module 1100 in order to obtain the device identification code ID(X) from the first wireless transceiving module 1100. When the second wireless transceiving module 1210 obtains the device identification code ID(X) from the first wireless transceiving module 1100, the processor 1220 may search for the at least one set of data to check whether the device identification code ID(X) matches to the pre-built identification code(s) ID1˜IDm stored in the storage module 1230 (i.e., the steps S306 and S308). When the device identification code matches to the pre-built identification code, the flowchart goes to Step S410; or when the device identification code does not match to the pre-built identification code, the flowchart goes to Step S320. In this case, the acceleration detector 2240 may detect an acceleration behavior of the portable device 2200 (i.e., the Step S410); and the processor 2220 may determine whether to execute the corresponding pre-assigned instruction ITR1˜ITRm according to the acceleration behavior (i.e., the step S420). When the acceleration behavior is determined to be car moving, the flowchart goes to Step S310 in order to automatically execute the corresponding pre-assigned instruction; or when the acceleration behavior is determined to be car stop, the flowchart goes to Step S320 in order not to execute the corresponding pre-assigned instruction. Moreover, the flowchart shown in FIG. 4 may be suitable for the third case mentioned above.

These methods may include other intermediate steps or several steps may be merged into a single step without departing from the spirit of the present disclosure, which also belongs to the scope of the present disclosure. For example, a step of activating the second wireless transceiving module and/or the acceleration detector only when a command related to the corresponding application (such as, launching a SMS program or receiving an incoming call) is received maybe inserted before the step S304 of the flowcharts shown in FIG. 3 and FIG. 4, and thus a goal of saving the power consumption of the portable device may be achieved.

In summary, the disclosure provides an electronic system and a related controlling method. By storing the pre-built identification codes ID1˜IDm in the portable device in advance, the portable device may be able to automatically execute the corresponding pre-assigned instructions ITR1˜ITRm when the device identification code ID(X) matches to one of the pre-built identification codes ID1˜IDm. As a result, the user does not need to enable or disable the corresponding application(s) manually, such as disabling a SMS program or enabling a mute function of the portable device. Additionally, in order to save power consumption, the second wireless transceiving module 1210 and/or the acceleration detector 2240 maybe designed to be activated only when a command related to the corresponding application is received. Therefore, the convenience of the portable device may be substantially improved.

Those skilled in the art will readily observe that numerous modifications and alterations of the device and method may be made while retaining the teachings of the invention.

What is claimed is:

1. An electronic system, comprising:
a first wireless transceiving module, having a device identification code; and
a portable device, comprising:
a second wireless transceiving module, for communicating with the first wireless transceiving module in order to obtain the device identification code from the first wireless transceiving module;
a storage module, for storing at least one set of data, wherein each set of data comprises a pre-built identification code and a corresponding pre-assigned instruction; and
a processor, coupled to the second wireless transceiving module and the storage module;
wherein when the second wireless transceiving module obtains the device identification code from the first wireless transceiving module, the processor searches for the at least one set of data to check whether the device identification code matches to the pre-built identification code stored in the storage module; and
when the device identification code matches to the pre-built identification code, the processor automatically executes the corresponding pre-assigned instruction.

2. The electronic system of claim 1, wherein the portable device further comprises:
an acceleration detector, coupled to the processor, for detecting an acceleration behavior of the portable device;
wherein when the device identification code matches to the pre-built identification code, the processor determines whether to execute the corresponding pre-assigned instruction according to the acceleration behavior.

3. The electronic system of claim 2, wherein the acceleration detector is a G sensor, a Wi-Fi module, an RFID module, a base station, a radio signal transceiving module, or a global positioning system (GPS) module.

4. The electronic system of claim 1, wherein the pre-assigned instruction indicates the processor to enable or disable a corresponding application.

5. The electronic system of claim 4, wherein the second wireless transceiving module is activated only when a command related to the corresponding application is received by the processor.

6. The electronic system of claim 1, wherein when the device identification code matches to the pre-built identification code, the processor automatically disables at least one of the following functions of the portable device including a short message service (SMS) program, a multimedia messaging service (MMS), a voice recognition, a speaker function, a microphone function, a data input function, a keyboard function, and a display function.

7. The electronic system of claim 1, wherein when the device identification code matches to the pre-built identification code, the processor automatically enables a mute function of the portable device.

8. The electronic system of claim 1, wherein the first wireless transceiving module is a Bluetooth module, a Wi-Fi module, an RFID module, a base station, a radio signal transceiving module, a ZigBee module, or an ANT/ANT+ module; and the second wireless transceiving module is a Bluetooth module, a Wi-Fi module, an RFID module, a base station, a radio signal transceiving module, a ZigBee module, or an ANT/ANT+ module.

9. The electronic system of claim 1, wherein the portable device is a cell phone, a personal digital assistant (PDA), a PDA phone, a smart phone, a hand held device, a e-book, a tablet, or a laptop.

10. A method for controlling an electronic system, the electronic system comprising a first wireless transceiving module having a device identification code and a portable device having a second wireless transceiving module, the method comprising the steps of:
storing at least one set of data in the portable device in advance, wherein each set of data comprises a pre-built identification code and a corresponding pre-assigned instruction;
communicating with the first wireless transceiving module in order to obtain the device identification code;
when the device identification code is obtained from the first wireless transceiving module, searching for the at least one set of data to check whether the device identification code matches to the pre-built identification code; and
when the device identification code matches to the pre-built identification code, automatically executing the corresponding pre-assigned instruction.

11. The method of claim 10, further comprising:
detecting an acceleration behavior of the portable device; and
when the device identification code matches to the pre-built identification code, determining whether to execute the corresponding pre-assigned instruction according to the acceleration behavior.

12. The method of claim 10, wherein the pre-assigned instruction indicates the processor to enable or disable a corresponding application.

13. The method of claim 12, further comprising:
activating the second wireless transceiving module only when a command related to the corresponding application is received.

14. The method of claim 10, wherein the step of executing the corresponding pre-assigned instruction comprises:
when the device identification code matches to the pre-built identification code, automatically disabling at least one of the following functions of the portable device including a short message service (SMS) program, a multimedia messaging service (MMS), a voice recognition, a speaker function, a microphone function, a data input function, a keyboard function, and a display function.

15. The method of claim 10, wherein the step of executing the corresponding pre-assigned instruction comprises:
when the device identification code matches to the pre-built identification code, automatically enabling a mute function of the portable device.
